(19) United States
(12) Patent Application Publication
(10) Pub. No.: US 2013/0193781 A1
(43) Pub. Date: Aug. 1, 2013

(54) INSULATED ELECTRIC MOTOR AND METHOD OF FORMING

(71) Applicants: Roy D. Rasmussen, Janesville, WI (US); Aaron M. Finke, Janesville, WI (US)

(72) Inventors: Roy D. Rasmussen, Janesville, WI (US); Aaron M. Finke, Janesville, WI (US)

(73) Assignee: HAMILTON SUNDSTRAND CORPORATION, Windsor Locks, CT (US)

(21) Appl. No.: 13/363,929

(22) Filed: Feb. 1, 2012

(51) Int. Cl. H02K 5/08; H02K 15/02

(52) U.S. Cl. 310/45; 29/596

(57) ABSTRACT

An insulated electric motor includes a stator core having a stator cavity. Also included is an adhering material disposed within at least one portion of the stator cavity. Further included is a filling substance disposed within the at least one portion of the stator cavity and adhered to the adhering material, wherein the adhering material and the filling substance substantially fill the stator cavity.

### BACKGROUND OF THE INVENTION

The present invention relates to electric motors, and more particularly to an insulated electric motor and methods for forming the same.

Electric motors often operate in a flammable leakage zone. As such, these motors are required to meet certain safety or other standards to reduce the probability of causing an injury or other damage due to their interaction with the operating environment. One such requirement limits the volume of free internal space within an electric motor assembly. The electric motor assembly is typically filled with an impregnation compound in an attempt to fill the free internal space and such a requirement. While the impregnation compound may prove effective for certain spaces, drawbacks exist for motors that include relatively large volumes of free internal space. Such drawbacks include the relatively expensive cost of the impregnation compound, as well as the impregnation compound being relatively dense, thereby hindering the ability to adequately fill the larger free internal spaces. Furthermore, when the impregnation compound is solely employed, the impregnation compound may be prone to fracture during a cure cycle, leading to undesirable free air space sections.

### BRIEF DESCRIPTION OF THE INVENTION

According to one embodiment, an insulated electric motor includes a stator core having a stator cavity. Also included is an adhering material disposed within at least one portion of the stator cavity. Further included is a filling substance disposed within the at least one portion of the stator cavity and adhered to the adhering material, wherein the adhering material and the filling substance substantially fill the stator cavity.

According to another embodiment, an insulated electric motor includes a stator core having a first stator winding and a second stator winding, wherein the second stator winding is disposed circumferentially adjacent to the first stator winding. Also included is a stator cavity comprising a gap between the first stator winding and the second stator winding. Further included is an adhering material disposed within the gap. Yet further included is a filling substance disposed within the gap and adhered to the adhering material, wherein the adhering material and the filling substance substantially fill the gap.

According to yet another embodiment, a method of forming an insulated electric motor is provided. The method includes disposing a first stator winding within a stator core. Also included is disposing a second stator winding within the stator core in a location circumferentially adjacent to the first stator winding, wherein a gap is disposed between the first stator winding and the second stator winding. Further included is installing an adhering material within at least one portion of the gap. Yet further included is dispensing a filling substance into the gap, wherein the filling substance adheres to the adhering material to substantially fill the gap.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a cross-sectional view of an insulated electric motor;

FIG. 2 is a perspective view of a stator core of the insulated electric motor; and

FIG. 3 is a plan view of an end of the stator core.

### DETAILED DESCRIPTION OF THE INVENTION

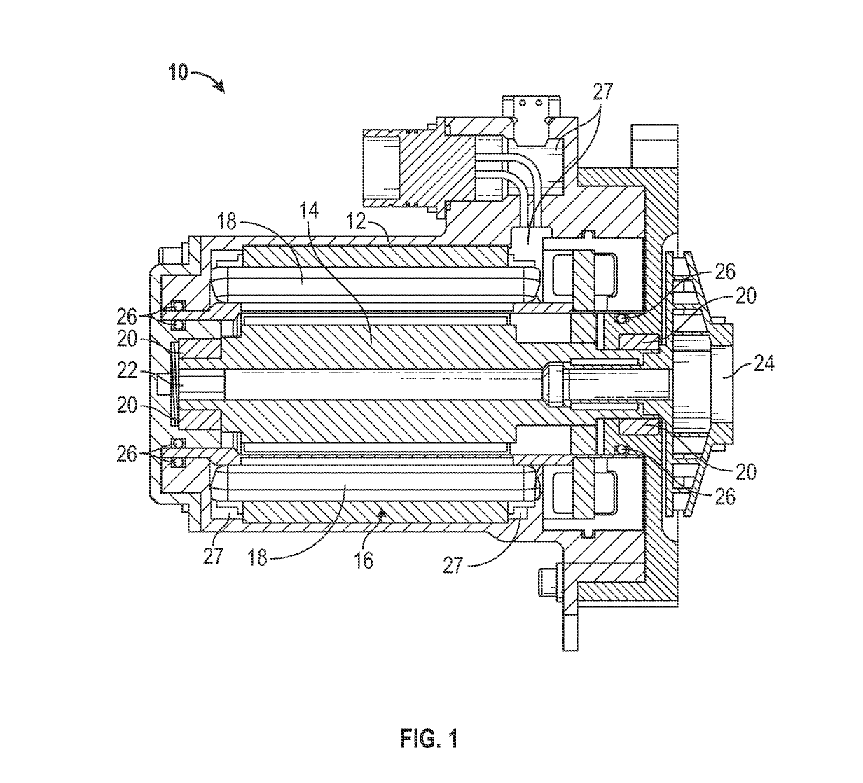

Referring to FIG. 1, an electric motor is generally illustrated with reference numeral 10. The specific configuration of the electric motor 10 does not affect the applicability of the embodiments described herein, but for illustrative purposes, the electric motor 10 may be configured as a permanent magnet motor or a switched reluctance motor, for example. The electric motor 10 is disposed within, and substantially enclosed by, a motor housing 12. The motor housing 12 operably supports and/or houses various components associated with the electric motor 10. The electric motor 10 generally includes a rotor 14, a stator core 16, at least one stator winding 18 and a plurality of rotor bearings 20.

The rotor 14 rotates a rotor shaft 22 and optionally an impeller 24 fitted thereon and it is to be appreciated that rotation of the rotor shaft 22 may be used to control any desired device. A plurality of seal components 26, such as O-rings, sleeves and/or a resolver, are disposed within the electric motor 10 to provide protection from ingress of debris and undesirable substances into the stator core 16, among other functional advantages. Throughout the stator core 16, a general region referred to as a stator cavity 27 is present and comprises any free space proximate the stator core 16, and more generally proximate the electric motor 10.

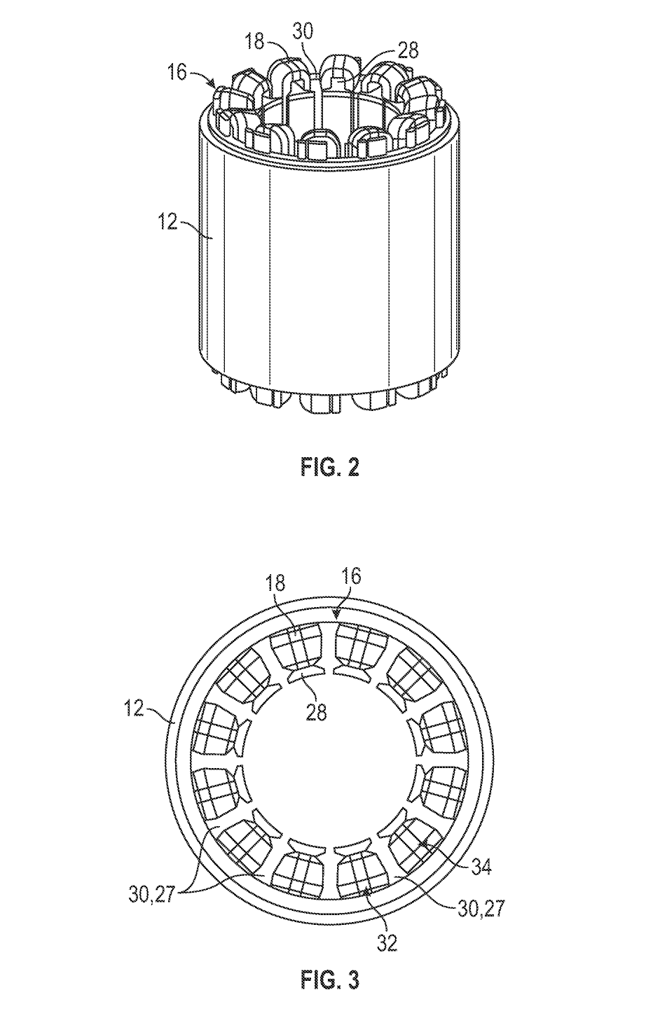

Referring to FIGS. 2 and 3, the stator core 16 disposed within the motor housing 12 is illustrated in greater detail. The stator core 16 includes at least one stator winding 18, but as shown, a plurality of stator windings are typically present. The stator core 16 also includes a plurality of stator teeth 28 disposed at a radially inward location of each stator winding 18. A plurality of gaps 30 are disposed between each of the plurality of stator windings 18, and more specifically each gap 30 is disposed between an adjacent pair of stator windings 18. By way of example, a first stator winding 32 is disposed relatively circumferentially adjacent to a second stator winding 34, with a gap 30 situated therebetween. Each of the plurality of gaps 30 define, at least in part, the stator cavity 27.

As described above, it is desirable to fill free space in the stator cavity 27 in certain operating environments. To fill free space in the stator cavity 27, such as the plurality of gaps 30, an electrically insulated material is disposed in the plurality of gaps 30. The electrically insulated material is an adhering material having a strong absorbing property. The adhering material may be a felt material, and more specifically, a foam backing made of fibrous aramid paper. In one embodiment, the foam backing is a finely knit foam that is substantially absorbing and sponge-like.

In addition to the adhering material, a filling substance is also disposed within the plurality of gaps 30 and upon deposition therein, is integrally formed with the adhering material. The filling substance may comprise an impregnation potting compound. The impregnation potting compound is impregnated into the desired regions of the stator cavity 27. The impregnation potting compound may be comprised of various substances, and one example includes silicone resin, silica, and/or aluminum fine powder. In order to disperse the impregnation potting compound adequately throughout the stator cavity 27, the stator core 16 may be subjected to a baking process in a furnace, then subsequently cooled. Subsequent to cooling, the impregnation potting compound becomes integrally formed with the adhering material and, in combination, forms a heat resistant insulation system that provides stable electric insulation performance in high temperature environments, if necessary, and also relatively fills the stator cavity 27 in a manner that prevents the invasion of flammable gases or other undesirable substances into the electric motor 10, and more specifically the stator cavity 27.

A method of forming the electric motor 10 is also provided. The electric motor 10 has been previously described and specific components need not be described in further detail. The method includes constructing the electric motor 10 and insulating the electric motor 10 with the adhering material and the filling substance in one or more locations throughout the electric motor 10, and more specifically the stator cavity 27, such as the plurality of gaps 30. The adhering material and filling substance may be introduced into the electric motor 10 at various points during the overall electric motor 10 assembly process. For example, the adhering material and/or the filling substance may be introduced just prior to installation of the stator core 16 to the motor housing 12. The stator cavity 27 comprises a certain volume of free space and the adhering material, in combination with the filling substance may be provided into the stator cavity 27 until various volumetric requirements are met. For example, the adhering material and filling substance, in combination, may be provided until less than one (1) cubic inch (16.4 cubic centimeters) of free space is present within the electric motor 10, and more specifically the stator cavity 27. As described above, in order to disperse the filling substance more thoroughly, a baking process may be employed to cause the filling substance to become situated throughout the stator cavity 27. The baking process is then followed with a cooling period that allows the filling substance to adhere to, and integrate with, the adhering material in order to fill the stator cavity 27 and form an insulation system throughout the stator cavity 27. The method provides the ability to fill large voids by using the impregnation potting compound to adhere to, saturate and fill the voids, in combination with the adhering material, rather than using the impregnation potting compound to solely perform this function.

Accordingly, the electric motor 10 increases the probability of adequate filling of the motor housing 12, and more specifically the stator cavity 27. Additionally, the adhering material is less dense than the filling substance, such that sufficient filling of the stator cavity 27 is achieved in a lighter and less costly manner than an electric motor 10 having complete filling of the stator cavity 27 with the filling substance, while meeting filling requirements.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An insulated electric motor comprising:
a stator core having a stator cavity;
an adhering material disposed within at least one portion of the stator cavity; and
a filling substance disposed within the at least one portion of the stator cavity and adhered to the adhering material, wherein the adhering material and the filling substance substantially fill the stator cavity.

2. The insulated electric motor of claim 1, wherein the stator core includes a plurality of stator windings, the plurality of stator windings forming a plurality of adjacent stator winding pairs.

3. The insulated electric motor of claim 2, further comprising a plurality of gaps disposed between each of the plurality of adjacent stator winding pairs.

4. The insulated electric motor of claim 1, further comprising a stator cavity free space defined by non-filled areas of the stator cavity, wherein the stator cavity free space is less than or equal to one cubic inch.

5. The insulated electric motor of claim 1, wherein the adhering material comprises a felt material that is electrically insulated.

6. An insulated electric motor comprising:
a stator core having a first stator winding and a second stator winding, wherein the second stator winding is disposed circumferentially adjacent to the first stator winding;
a stator cavity comprising a gap between the first stator winding and the second stator winding;
an adhering material disposed within the gap; and
a filling substance disposed within the gap and adhered to the adhering material, wherein the adhering material and the filling substance substantially fill the gap.

7. The insulated electric motor of claim 6, further comprising a plurality of gaps disposed between a plurality of adjacent stator windings, wherein the adhering material is disposed within the plurality of gaps, wherein the filling substance is disposed within each of the plurality of gaps and adhered to the adhering material.

8. The insulated electric motor of claim 6, further comprising a stator cavity free space defined by non-filled areas of the stator cavity, wherein the stator cavity free space is less than or equal to one cubic inch.

9. The insulated electric motor of claim 6, wherein the adhering material comprises a felt material that is electrically insulated.

10. The insulated electric motor of claim 6, wherein the adhering material comprises a fibrous aramid material.

11. The insulated electric motor of claim 6, wherein the stator cavity further comprises a space between a stator core outer diameter and a motor housing, wherein the adhering material is disposed in the stator cavity.

12. A method of forming an insulated electric motor comprising:
disposing a first stator winding within a stator core;
disposing a second stator winding within the stator core in a location circumferentially adjacent to the first stator winding, wherein a gap is disposed between the first stator winding and the second stator winding;
installing an adhering material within at least one portion of the gap; and
dispensing a filling substance into the gap, wherein the filling substance adheres to the adhering material to substantially fill the gap.

13. The method of claim 12, wherein the adhering material is installed within the at least one portion of the gap prior to the stator core being installed in a motor housing.

14. The method of claim 12, wherein dispensing the filling substance into the gap occurs until less than one cubic inch of a stator cavity free space is present.

15. The method of claim 12, wherein the adhering material comprises a felt material that is electrically insulated.

16. The method of claim 12, wherein the adhering material comprises a fibrous aramid material.
